(19) United States
(12) Patent Application Publication
(10) Pub. No.: US 2007/0042695 A1
(43) Pub. Date: Feb. 22, 2007

(54) Oyster shucking block

(76) Inventors: Ian M. Chong, Seattle, WA (US); Jeffrey B. Johnson, Bellevue, WA (US)

Correspondence Address: BLACK LOWE & GRAHAM, PLLC, 701 FIFTH AVENUE, SUITE 4800, SEATTLE, WA, 98104, US

(21) Appl. No.: 11/320,522

(22) Filed: Dec. 27, 2005

Related U.S. Application Data
(60) Provisional application No. 60/639,848, filed on Dec. 27, 2004.

(51) Int. Cl. A22C 29/04

(52) U.S. Cl. 452/16

(57) ABSTRACT

An oyster block includes a base. The base has a generally planar first surface; and an arcuate bulkhead attached to the base. The arcuate bulkhead, in cooperation with the generally planar first surface, defines an oyster receptacle. The oyster receptacle secures the oyster in the course of insertion or prying of the oyster shell.

### PRIORITY CLAIM

This application claims the benefit of U.S. patent application Ser. No. 60/639,848, filed on Dec. 27, 2004, incorporated here by reference.

### BACKGROUND OF THE INVENTION

The most popular shucking method for shucking an oyster is called prying. The oyster is opened from the back or hinge area. Prying is possible because today the knife blades are made of hard metals and cannot be snapped in two by the force of prying.

In prying, the oyster is grasped with either a bar towel or a glove with the flatter side up. The oyster knife is used like a key; locating the seam near the hinge, a shucker inserts a tip and blade of the oyster knife with great force to a position where a twist of the oyster knife opens the oyster shell.

The action of prying requires the exertion of great pressure, is tiring, and straining. Repetitive motion disorders (“RMDs”) are a family of muscular conditions that result from repeated motions performed in the course of normal work or daily activities. RMDs include carpal tunnel syndrome, bursitis, tendonitis, epicondylitis, ganglion cyst, tenosynovitis, and trigger finger. RMDs are caused by too many uninterrupted repetitions of an activity or motion, unnatural or awkward motions such as twisting the arm or wrist, overexertion, incorrect posture, or muscle fatigue. In the case of shucking oysters, the great pressure to insert the oyster knife is also exerted on the socket of the shucker's shoulder tending to draw it out of socket.

Over time, RMDs can cause temporary or permanent damage to the soft tissues in the body—such as the muscles, nerves, tendons, and ligaments—and compression of nerves or tissue. Oyster shuckers often suffer RMDs in and near their right shoulder socket due to the great pressure necessary to insert the knife.

Additionally, the act of inserting the knife can if done improperly propel the knife into the flesh of the left oyster-holding hand. Such knife-induced injuries may result in infection or severing of muscles, tendons, or nerves.

What is needed in the art is a safe apparatus for shucking oysters.

### BRIEF SUMMARY OF THE INVENTION

An oyster block includes a base having a generally planar first surface as well as an arcuate bulkhead attached to the base defining, in cooperation with the generally planar first surface, an oyster receptacle. The oyster receptacle securely holds the oyster as the shucker inserts and pries the oyster shell open.

An embodiment of the block includes a first handle on a second surface of the base, the first handle allowing for the ready movement of the block from workplace to workplace, exploiting the portable nature of the block. Because the block is often used in wet environments, an advantageous option includes configuring the handle to include a finger rest with a first series of spaced apart ridges. An additional option is placing a second handle in opposed relationship to the first thereby allowing the block to be securely held in both hands when transported.

In another preferred embodiment, the first surface includes a non-slip surface. The non-slip surface might be inset into the first surface or, in an additional embodiment the non-slip surface is a non-slip mat.

Advantageously, the base may optionally be configured to include a receptacle configured to hold an oyster knife. The base may also include a holding means for securing an oyster knife within the receptacle. In an embodiment, the holding means is a magnet.

An additional embodiment includes a base that is formed of a monolithic solid prism allowing single step manufacturing of the block.

### BRIEF DESCRIPTION OF THE DRAWINGS

Preferred and alternative embodiments of the present invention are described in detail below with reference to the following drawings.

FIG. 1 is an isometric view of the oyster shucking block;

FIG. 2 is a reverse isometric view of the oyster shucking block; and,

FIG. 3 is an isometric view of the underside of the shucking block.

### DETAILED DESCRIPTION OF THE PREFERRED EMBODIMENT

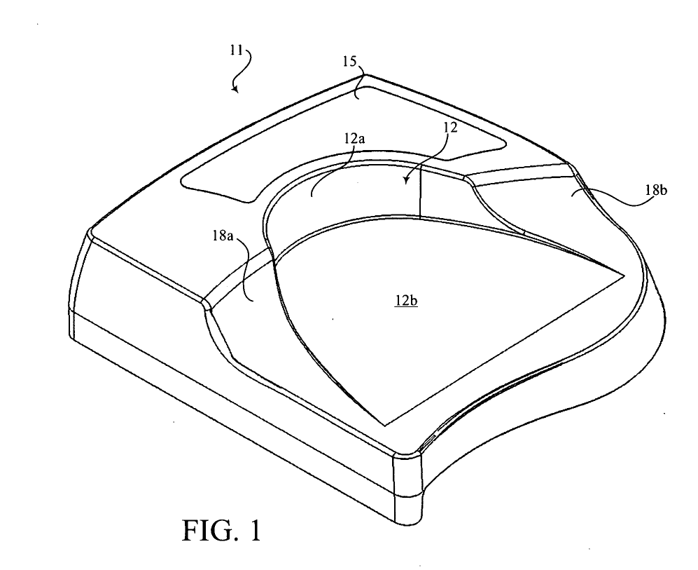

FIG. 1 is an isometric view of a shucking block 11 that includes an oyster receptacle 12 defined in a solid prism. The oyster receptacle 12 is configured to include a concavity to receive the oyster formed by an arcuate bulkhead 12a and a first surface 12b. In another embodiment, a mat extending over all or a portion of the first surface 12b may retain the oyster in the receptacle in non-slip engagement. The mat may be attached to or only rest upon the first surface 12b. A removable mat allows easier cleaning of the device.

Depressions 18a and 18b are configured to allow access to the knot of the oyster when the oyster is received in the oyster receptacle 12. A rest 15 is provided on an upper surface of the shucking block 11 to allow one hand to hold the block against a work surface and secure the oyster in the oyster receptacle 12.

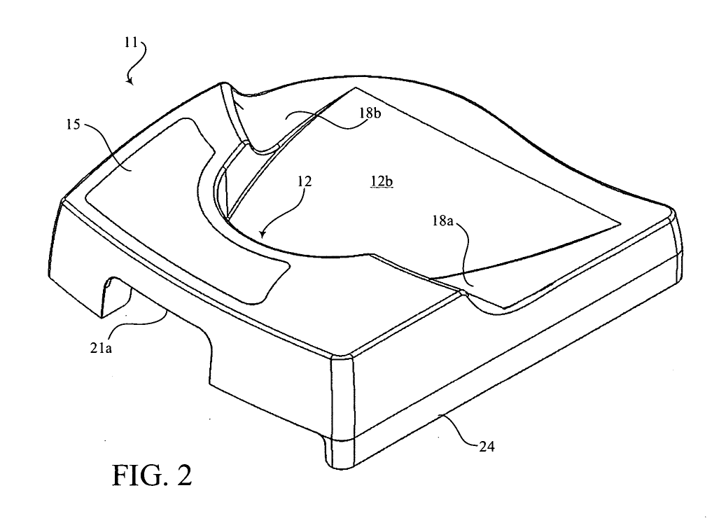

FIG. 2 is a reverse isometric view of the shucking block 11. A step 24 allows the block 11 to be secured in biased engagement against an edge of a counter, tabletop, or other work surface. The step 24 secures the block 11 against the work surface to allow a person to insert an oyster knife with an insertion force such that application of the insertion force will not cause movement of the shucking block and with the block, the oyster. In alternative embodiments, the step 24 could be shifted away from the edge of the block 11 or be made of a series of smaller steps in a manner that would preserve the step's 24 function: to prevent the block from moving when a force was applied with an oyster knife to an oyster resting in the oyster receptacle.

A second surface 14, which is generally perpendicular to the first surface 12, optionally includes a defined cutout 21 that serves as a first handle to assist in moving the block from an engaging position relative to the tabletop or counter. The block is a portable device, so having a handle makes it easier to carry from place to place. A first series of spaced apart ridges 21a extend to and in concert with the cutout 21 serve to form a finger rest. The series of spaced apart ridges 21 forms a self-cleaning, non-fouling surface that allows a secure grip when the fingers may be covered with the viscera of shucked oysters.

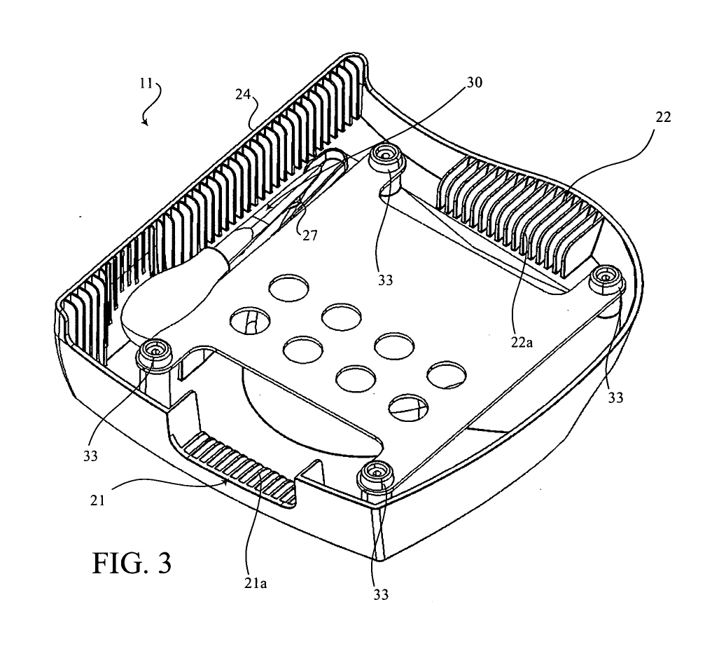

FIG. 3 is an isometric view of the underside of the shucking block. A third surface 16, which is generally perpendicular to the first surface 12 and in opposed relation to the second surface 14, includes a defined cutout 22 which serves as a second handle to assist in moving the block from an engaging position relative to the tabletop, counter, or other generally planar work surface. The second handle is desirable because the shucker may advantageously use a two handed grip of the block making the block easier to carry. A second series of spaced apart ridges 22a in concert with the cutout 22 advantageously forms a second finger rest. As with the first series of spaced apart ridges, the second series of spaced apart ridges forms a self-cleaning, non-fouling surface that allows a secure grip when the fingers may be covered with the viscera of shucked oysters. Non-slip feet 33 attached to a fourth surface 34 help to secure the block 11 in biased engagement with the tabletop or counter with or without the operation of the optional step 24.

Optionally, a receptacle 32 is defined for storing an oyster knife 30 on the underside of the block 11 by suitable means. Where present, the receptacle reduces the likelihood of losing the oyster knife 30. In one embodiment, a magnet 27 secures the knife 30. This is a simple, but effective means to secure the oyster knife 30 by attracting the metal blade of the oyster knife 30. Other suitable catchment devices may optionally be used to retain the oyster knife 30 within the receptacle 34.

While the preferred embodiment of the invention has been illustrated and described, as noted above, many changes can be made without departing from the spirit and scope of the invention. For example, the oyster knife may be secured to the underside of the block by many methods other than a magnet, including but not limited to a latch, a cover, a clip, or a receptacle configured such that it has somewhat flexible sides that grip the oyster knife when inserted. Also, for example, rather than using a non-slip mat, all or a portion of the first surface may be formed of a non-slip material or rather than using non-slip feet, all or a portion of the fourth surface may be formed of a non-slip material. Additionally, the surfaces and regions of the base may be formed of separate parts that when attached or bonded together form the block or the base may be made of a monolithic material which is configured such that all of the surfaces and regions are formed from a single part.

What is claimed is:

1. An oyster block comprising:
a base having a generally planar first surface; and
an arcuate bulkhead attached to the base defining, in cooperation with the generally planar first surface, an oyster receptacle.

2. The block of claim 1, wherein the base includes a first handle.

3. The block of claim 2, wherein:
the base includes a second surface generally perpendicular to the first surface, the second surface defining the first handle.

4. The block of claim 3, wherein:
the second surface further defines a first series of spaced apart ridges; and
the first handle includes a first finger rest, the first finger rest including the first series of spaced apart ridges.

5. The block of claim 2, wherein the base includes a second handle in opposed relation to the first handle.

6. The block of claim 5, wherein:
the base includes a third surface generally perpendicular to the first surface and in opposed relation to the second surface, the third surface defining the second handle.

7. The block of claim 6, wherein:
the third surface further defines a second series of spaced apart ridges; and
the second handle includes a second finger rest, the second finger rest including the second series of spaced apart ridges.

8. The block of claim 1, wherein the planar first surface includes a non-slip surface.

9. The block of claim 8, wherein the non-slip surface is a non-slip mat.

10. The block of claim 1, wherein the base includes a receptacle configured to hold an oyster knife.

11. The block of claim 10, wherein:
the base includes a holding means for securing an oyster knife within the receptacle.

12. The block of claim 7, wherein the holding means is a magnet.

13. The block of claim 1, wherein the base includes a fourth generally planar surface in opposed relationship to the first planar surface.

14. The block of claim 13, wherein the fourth planar surface includes non-slip inset.

15. The block of claim 14, wherein the non-slip inset comprises a plurality of rubber feet.

16. The block of claim 13, wherein the fourth generally planar surface includes a step for securing the block in biased engagement against an edge of a work surface.

17. The block of claim 1, wherein the block is formed of a monolithic material.

18. An oyster shucking block comprising:
a base having a first generally planar surface, the surface defining a first receptacle configured to receive an oyster in biased engagement through application of a biasing force.

19. The block of claim 18, wherein the base defines a first cutout in a first side of the block, the first cutout being configured for use as a handle, the first side being distinct from the first generally planar surface.

20. The block of claim 19, wherein the base includes a second side defining a second cutout, the second side being in opposed relation to the first side of the block, the second cutout being configured for use as a second handle.

21. The block of claim 18, wherein the first receptacle includes a non-slip surface.

22. The block of claim 21, wherein the non-slip surface is a non-slip mat.

23. The block of claim 18, wherein the base includes a second receptacle configured to hold an oyster knife.

24. The block of claim 23, further comprising:
a holding means configured to secure an oyster knife in the second receptacle.

25. The block of claim 24, wherein the holding means includes a magnet.

26. The block of claim 18, wherein the base includes a non-slip surface in opposed relation to the first generally planar surface and configured to engage a work surface.

27. The block of claim 26, wherein the non-slip surface comprises a plurality of rubber feet.

28. The block of claim 18, wherein the base also has an upper surface surrounding a portion of the first receptacle and wherein the base is configured to produce depressions from the upper surface, the contours of which lead to a lower surface that extends into the first receptacle.
